(19) United States
(12) Patent Application Publication
(10) Pub. No.: US 2006/0108473 A1
(43) Pub. Date: May 25, 2006

(54) EMERGENCY LANDING SYSTEM - FIXED WING AIRPLANE

(75) Inventor: Polchai Phanumphai, Bangkok (TH)

Correspondence Address: RACHASAK PHANUMPHAI, 9417 E. ARIZONA PLACE, DENVER, CO, 80247, US

(73) Assignee: Polchai Phanumphai, Bangkok (TH)

(21) Appl. No.: 10/904,675

(22) Filed: Nov. 23, 2004

(51) Int. Cl. B64C 25/54

(52) U.S. Cl. 244/110 A

(57) ABSTRACT

The purpose of this invention is to prevent and/or reduce the loss of life during an emergency landing of an airplane away from an airport environment. This is possible by eliminating one of its wings and using the other wing to perform in the same manner as the rotor of a helicopter. Thus, the whole airplane will spin because of its momentum imbalance, and a transferring linear momentum into angular momentum. The airplane will in effect be in a controlled auto-rotation and the altitude and ground approach velocity will be greatly reduced to a near zero speed upon touchdown. The result can be achieved by placing controlled explosive devices coupled with a rocket or jet inside one of the wing structures. The explosives devices and the rocket/jet engine, with the direction of thrust to the front, will cause the wing to separate from the fuselage and provide a very strong lateral impulse or spin on a horizontal plane. This lateral spin with one wing remaining will provide the centrifugal force required to maintain auto-rotation and the remaining wing will provide the control surface to maintain lift necessary to maintain the horizontal attitude of the airplane until it reaches the ground.

Currently, there are no emergency landing systems for fixed wing airplane that adequately protect passengers while performing an emergency landing at a distance from an airport facility.

As we all know, airplane accidents can create great cost in casualties in the air and on the ground, as well as great property losses. Upon analysis, it can be said that the greatest number of casualties are not a result of high altitude, but because of the high velocity impact and incorrect airplane approach attitude on the horizontal plane. The purpose of this invention is to provide a means to correct and control the approach attitude and to reduce the horizontal speed to near zero velocity when the airplane touches down. This will result in greatly reduced numbers of casualties and reduce the numbers and severity of major injuries.

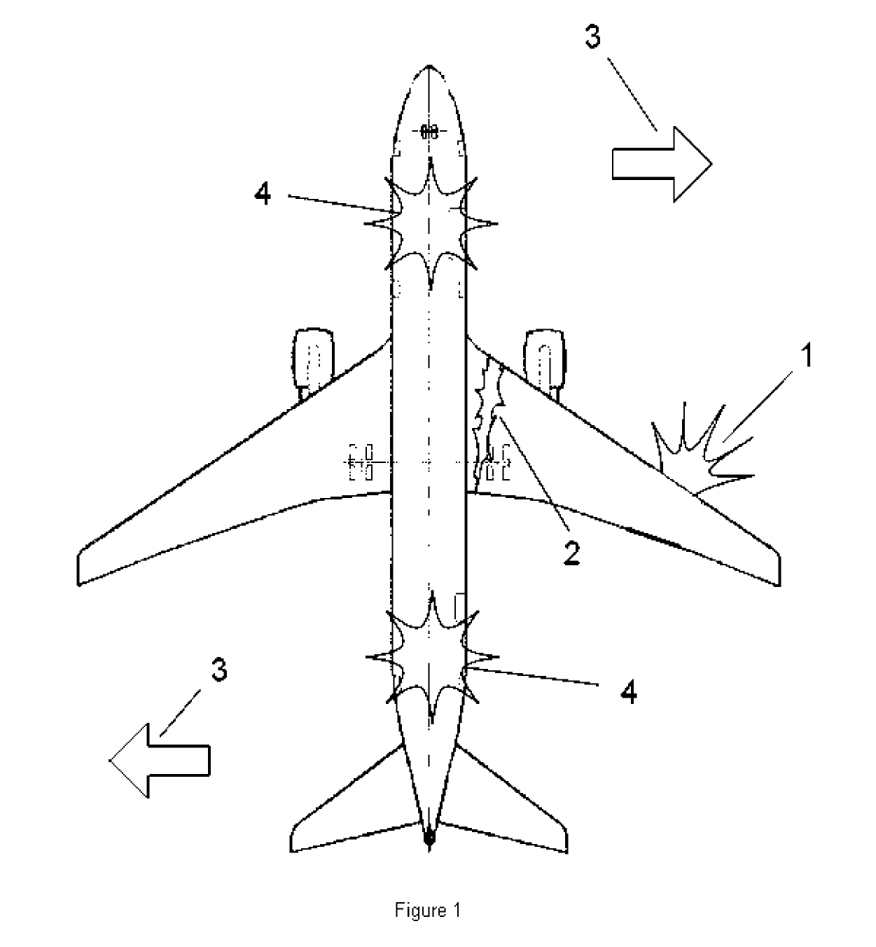

FIG. 1—View from underneath the airplane of this invention

An airplane, in immediate risk of crash landing, equipped with the emergency landing system needs to perform an emergency landing away from an airport environment. The scenario using the system is as follows:

The pilot activates the emergency landing system (in case of a terrorist threat, the system is designed so that it may also be activated remotely from the ground or another airplane). Upon activation the plane will still be flying (based on the conditions of the existing emergency), and the pilot(s), even in a no power situation, will be then able to decrease altitude. At the predetermined altitude (depending upon types of airplane), a signal from the altimeter will detonate the explosive charges, with the thrust forward 1, causing a controlled separation of the wing, and the thrust needed to cause a very strong force in the rearward direction of this wing. The explosive devices will provide enough to break the wing from the airplane at the fuselage 2. This force will then, make the whole airplane spin on a horizontal plane and in the direction of the missing wing 3. This spin will cause the following:
(1) The spin will cause centrifugal force between the wing that remains intact and the fuselage. Thus maintaining the horizontal plane of the airplane while in a spiral spin.
(2) The spin will cause the intact wing to work in the same manner as the rotor of the helicopter, producing lift, so that the airplane slowly decreases altitude, instead of a free fall descent.
(3) During the rotation spin, the fuselage and vertical stabilizer will help in decreasing speed, because of friction with the air.
(4) The airplane will decrease altitude at a much slower rate. If the emergency landing occurs in a forested area, the peaks of the trees will provide a cushion to help absorb rotation/impact energy.
(5) If the emergency landing occurs on open land or over water, the ground effect which will be present increases the lift efficiency of the wing by about 25%, increasing the “soft” landing effect.

When the airplane achieves a close proximity to the ground, a set of rockets or jets mounted under the fuselage 4 will ignite, with a downward thrust. This downward thrust will further slow the descent of the airplane and thus give a softer landing.

An additional advantage of this invention is that it can be used as terrorist deterrent. In case of hijacking, the remote control capabilities from ground or interceptor airplane may be employed to bring the airplane to ground prior to it being used as an airborne weapon, far from the anticipated target, and in an area that can be controlled to reduce the loss of life from such an event as was seen on 9/11.

In conclusion, to reduce the number of fatalities in most airplane crashes, it is necessary to lower the air speed and descent rate of the airplane in a controlled manner.

Through utilization of all aspects of this emergency landing system, initiated from within the at risk airplane or remotely, both the air speed and rate of descent can be reduced to controlled and sustainable speed/rate, thus providing a greater possibility of reducing the loss of life to a minimum.

What is claimed is:

1. Any means of eliminating one of the airplane wings in a rearward direction by using an explosive or retro-rockets.

2. Any method of reducing airplane forward speed, and transferring linear momentum into angular momentum. Transfer of forward velocity to create spin around the center of gravity.

3. Any method that will result in the fixed wing airplane being able to auto-rotate by transferring it's linear momentum to angular momentum and use the fuselage and remaining wing to produce lift, the same as a helicopter in auto-rotation. This system is designed to work even when forward velocity is lower than stall speed.

4. Any means to reduce the horizontal velocity of the airplane. Rotate the fuselage and use the side of the fuselage and the vertical stabilizer as an air brake.

5. Any means to slow the descent of the airplane by utilizing retro-rockets or jets under the fuselage. The downward thrust of the retro-jets will soften the landing.

6. The emergency landing system for a fixed wing airplane as in claim 1-5, where the said system is capable of being operated remotely from ground or interceptor airplane.
